(19) United States
(12) Patent Application Publication
(10) Pub. No.: US 2007/0244592 A1
(43) Pub. Date: Oct. 18, 2007

(54) MANUFACTURING SYSTEM WITH ACTIVE FAILOVER

(75) Inventors: Mohd Azizi Chik, Sungai Petani (MY); Tin Tin Ung, Singapore (SG); Thangappan Krisnamuthi, Larkin (MY); Kian Wee Lim, Singapore (SG); Lip Hong Lim, Singapore (SG); Brandon Lee, Singapore (SG)

Correspondence Address: ISHIMARU & ZAHRT LLP, 333 W. EL CAMINO REAL, SUITE 330, SUNNYVALE, CA, 94087, US

(73) Assignee: CHARTERED SEMICONDUCTOR MANUFACTURING LTD., Singapore (SG)

(21) Appl. No.: 11/736,255

(22) Filed: Apr. 17, 2007

Related U.S. Application Data
(60) Provisional application No. 60/745,000, filed on Apr. 17, 2006.

(51) Int. Cl. G06F 19/00

(52) U.S. Cl. 700/100

(57) ABSTRACT

A manufacturing system includes an event trigger to a primary server and a schedule server, forming a control job by the primary server and the schedule server, checks status (such as an end value trigger) of the primary server with a delay by the schedule server, and validating the status of the primary server with a validation process before the schedule server transmits the control job.

### CROSS-REFERENCE TO RELATED APPLICATION(S)

This application claims the benefit of U.S. Provisional Patent Application Ser. No. 60/745,000 filed Apr. 17, 2006.

### TECHNICAL FIELD

The present invention relates generally to the field of manufacturing, and more specifically to manufacturing systems with failover.

### BACKGROUND ART

Semiconductor systems have infiltrated all aspects of everyday life. For instance, semiconductor systems in the form of integrated circuit chips are commonplace in today's electronic devices such as cell phones, portable music players, video game players, notebook computers, televisions and even automobiles. The semiconductor industry has constantly driven manufacturing systems to increase the quality, reliability and throughput of integrated circuit devices, e.g. microprocessors and memory devices. This drive is a result of consumer demands for higher quality electronic devices that operate more reliably resulting in a continual improvement in manufacturing semiconductor devices such as transistor as well as manufacturing integrated circuit devices with such transistors. Reducing defects also lowers the overall cost per transistor and the cost of integrated circuit devices.

Generally, a set of processing steps is performed on a lot of wafers using a variety of process tools, including photolithography steppers, etch tools, deposition tools, polishing tools, rapid thermal process tools, implantation tools, etc. The technologies underlying semiconductor process tools have attracted increased attention over the last several years, resulting in substantial refinements. These technologies form a plurality of layers on a semiconductor wafer or other substrate. With advances in technology, integrated circuits have become increasingly complex and typically include multiple layers of intricate wiring. The number of integrated circuits on a single wafer has increased as the size of the integrated circuits decrease. The numbers have further increased as the standard size of the semiconductor wafers increased in diameter.

As a result of the increased complexity and decreased size of the integrated circuits, the value of the semiconductor wafer increases substantially as the wafer progresses through the various processing stages. At the same time, the increased weight of a pod or boat of wafers creates ergonomic problems in manual wafer handling. Thus, considerable care must be taken in handling the semiconductor wafers, particularly during the later processing stages, since damaged wafers could result in considerable monetary losses. Further restraints on the systems, which may be used to transfer the material, are placed by the requirement of a clean room environment substantially free of particulate contamination.

Automated material handling systems (AMHSs) have been used extensively in the semiconductor fabrication field. The typical system includes a plurality of bays (rows) of storage areas. Each bay has a stocker, which includes bins for holding a plurality of containers, such as standard mechanical interface (SMIF) pods for loading 200 mm (8 inch) wafers, or front opening unified pods (FOUPs) for loading 300 mm (12 inch) wafers. The general trend is now to moving away from SMIF pods towards FOUPs although both are sometimes used in the same system. For purposes of clarity, the term FOUP will be used to cover both types of containers. The stocker holds the FOUPs in preparation for transporting a FOUP to the loadport of a processing tool.

One technique for improving the operation of a semiconductor processing line includes using a factory wide control system such as manufacturing execution systems (MES) to automatically control the operation of the various process tools. The manufacturing tools communicate with a manufacturing framework or a network of processing modules. Each manufacturing tool is generally connected to an equipment interface. The equipment interface is connected to a machine interface that facilitates communications between the manufacturing tool and the manufacturing framework. The machine interface can generally be part of an advanced process control (APC) system. The APC system initiates a control script based upon a manufacturing model, which can be a software program that automatically retrieves the data needed to execute a manufacturing process.

In a fabrication facility, a dispatch system is provided for scheduling wafers through the required process and metrology steps. The dispatch system seeks to optimize tool utilization, improve product quality, and provide a smooth flow of product through the fabrication facility. Typically, the dispatch system uses a priority system and a backup system that gives higher priority lots preferred access to the various tools. Priorities may be determined based on factors such as device type, manufacturing requirements, anticipated performance, business goals, etc. Since the dispatch systems make the lots to be delivered at the optimized cycle time, it is critical to ensure the system is always available. As for all systems, a major concern is increasing reliability to reduce down time and increase profitability. This is especially true since modern semiconductor fabrication plants cost billions of dollars.

The concerns facing semiconductor systems can also affect other manufacturing systems. Some of the attempted manufacturing system improvements have sought to provide event trigger responses and failover. Previous attempts have not only failed to solve the concerns but many times caused new problems. For example, duplicate control jobs caused system issues including failures. Long delays often result from restarting control jobs. Incorrect restarts are sometimes due to loss of “in flight” data already transmitted. Unnecessary restarts can be due to faulty determination of failures including misinterpretation of system or application status. An example of the impact of the data misinterpretation will cause the system to be unable to deliver the lots to process or to the respective process equipment. Lots that finish process may not be able to deliver to a next process, and also may cause double processing of some respective lots. Overall, all of this impact may cause a high percentage of productivity loss that results in millions of dollars of loss.

Thus, a need still remains for a manufacturing system to increase reliability thereby reducing down time and increasing profitability. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides an event trigger to a primary server and a schedule server, forming a control job by the primary server and the schedule server, checking status of the primary server with a delay by the schedule server, and validating the status of the primary server with a validation process before the schedule server transmits the control job.

Certain embodiments of the invention have other advantages in addition to or in place of those mentioned above. The advantages will become apparent to those skilled in the art from a reading of the following detailed description when taken with reference to the accompanying drawings.

### BRIEF DESCRIPTION OF THE DRAWINGS

FIG. 1 is a plan view of a manufacturing system in an embodiment of the present invention;

FIG. 2 is a flow chart of a flow chart of a manufacturing system in an alternative embodiment of the present invention;

FIG. 3 is a flowchart of automatic decision-making and dispatching for the manufacturing system;

FIG. 4 is an isometric view of the manufacturing system; and

FIG. 5 is a flow chart of a manufacturing system 500 for implementing the manufacturing system 100 in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

For expository purposes, the term “horizontal” as used herein is defined as a plane parallel to the plane or surface of the invention, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “upper”, “over”, and “under”, are defined with respect to the horizontal plane.

The term “on” as used herein means and refers to direct contact among elements. The term “processing” as used herein includes deposition of material, patterning, exposure, development, etching, cleaning, and/or removal of the material or trimming as required in forming a described structure. The term “system” as used herein means and refers to the method and to the apparatus of the present invention in accordance with the context in which the term is used.

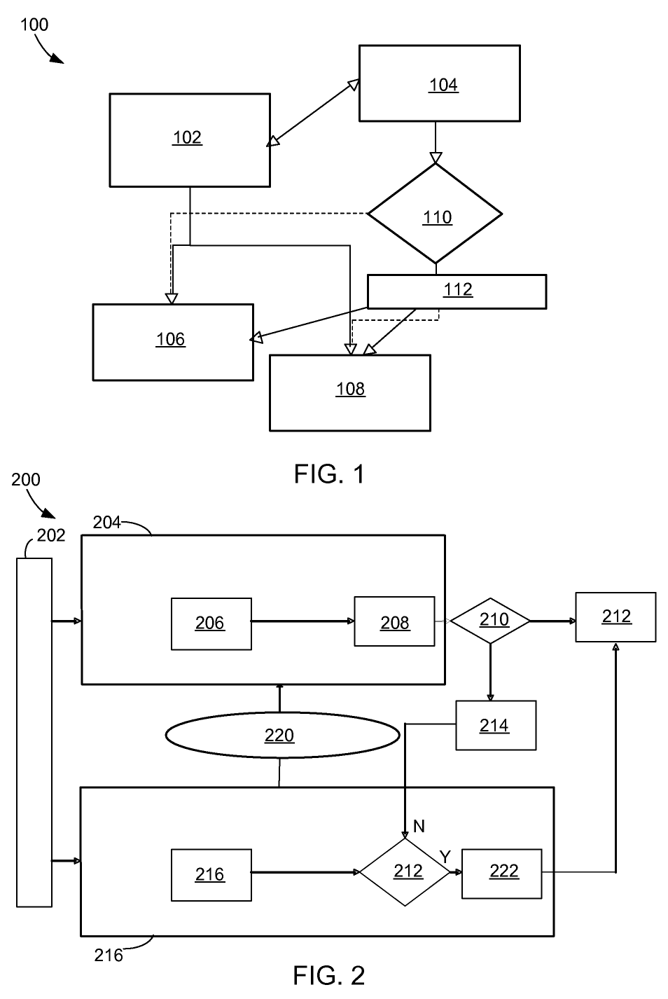

Referring now to FIG. 1, therein is shown a plan view of a manufacturing system 100 in an embodiment of the present invention. The manufacturing system 100 can preferably include a primary server 102, a schedule server 104, a first process server 106 such as a dispatch server, and a second process server 108 such as a dispatch server. The primary server 102 and the schedule server 104 provide detection of event triggers for executing action into the system. The event triggers result in forming a control job by the primary server 102 and the schedule server 104. The primary server 102 provides the control job for executing action into the manufacturing system 100.

The schedule server 104 checks status, such as an end value trigger, of the primary server 102. The status results are validated with a validation process in a block 110 that can preferably include information from the first process server 106 or the second process server 108. If a final results checking process in a block 112 confirm the status of the primary server 102 and the results of the validation process in the block 110 that the primary server 102 did not transmit the control job, the schedule server 104 transmits the control job to execute the action into the manufacturing system 100 providing Poka Yoke or mistake-proofing.

The schedule server 104 is delayed, such as twenty to forty seconds from forming the control job, to check status, validated status results, and eliminate duplication of the control job. Executing duplicates of the control job can result in higher loading and incorrect feedback. Eliminating duplication of the control job provides decreased loading as well as increased performance of the manufacturing system 100.

The manufacturing system 100 can include several processes such as direct tool-to-tool automated material handling system (AMHS) delivery such as WhereNext, automatic lot selection through real time dispatch (RTD) such as WhatNext, AMHS delivery, systems automatic processing (Track In & Out) with manual delivery, or systems processing off with manual input into systems and delivery such as Offline. Automation modes can be provided for processing such as three hundred millimeter wafers.

For example a first mode can include systems automatic processing (Track In & Out) with manual delivery, a second mode can include AMHS delivery with the first mode, a third mode can include automatic lot selection through RTD with the second mode, and a fourth mode can include direct tool-to-tool AMHS delivery with the third mode.

It has been discovered that the manufacturing system 100 including the schedule server 104, the validation process in the block 110, the final results checking process in the block 112, and a delay from forming the control job, provides substantially real time fail over from the primary server 102 to the schedule server 104 eliminating more than one of the same control job.

Referring now to FIG. 2, therein is shown a flow chart of a manufacturing system 200 in an alternative embodiment of the present invention. The flow chart of the manufacturing system 200 describes execution of events in a manner similar to the manufacturing system 100. An event trigger, such as an unload request (UnloadReq) changed to a load request (LoadReq), in a block 202 inputs to a primary activation process in a block 204.

The primary activation process includes a primary real time dispatch process (RTD) in a block 206. The primary real time dispatch process in the block 206 provides a returned lot list to the primary server 102 of FIG. 1 starting a lot reservation and transportation control job process in a block 208. The lot reservation in the block 208 is verified in a block 210. If the lot reservation in the block 208 is successful, the transportation control job in the block 208 is executed and the lot will be dispatched in a block 212. If the lot reservation in the block 208 is unsuccessful, the transportation control job in the block 208 is completed in a block 214.

The event trigger also inputs to a failover activation process in a block 216. The failover activation process includes a failover real time dispatch process (RTD) in a block 218. The failover real time dispatch process in the block 218 provides a returned lot list to the schedule server 104 of FIG. 1 and checks the primary server 102 for hardware and application health in a block 220. The failover activation process in the block 216 also validates the lot reservation based on whether the transportation control job in the block 208 is completed in the block 214 with a validation process in a block 222. If the lot reservation was unsuccessful, the schedule server 104 starts a lot reservation and transportation control job in a block 224 and the lot will be dispatched in the block 214.

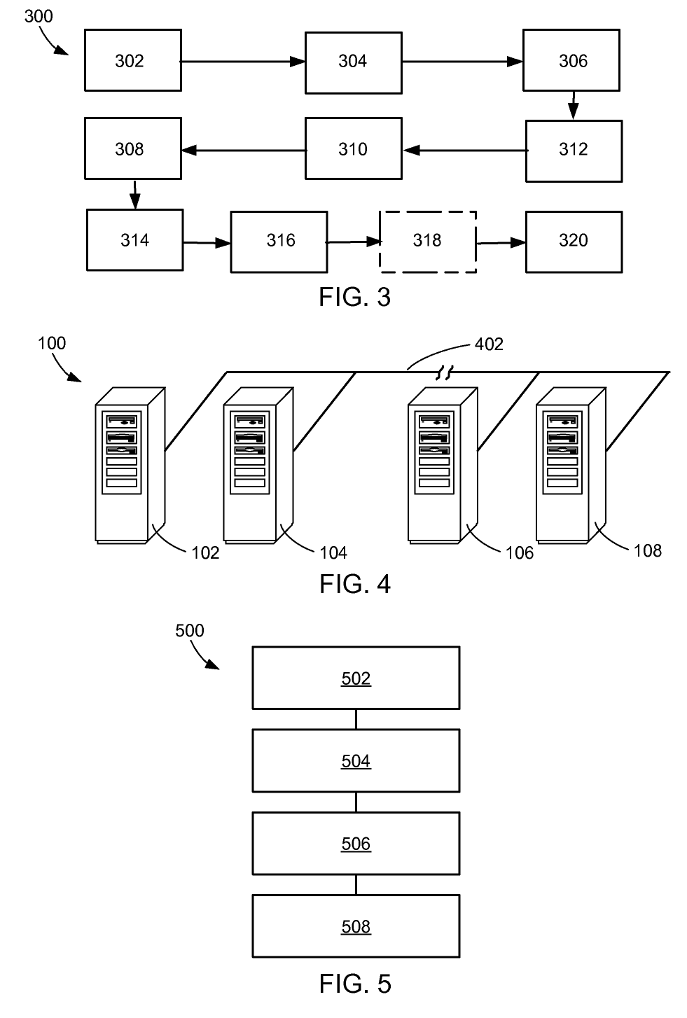

Referring now to FIG. 3, therein is shown a flowchart of automatic decision-making and dispatching 300 for the manufacturing system 100. Automatic decision-making or dispatching can include processes such as check tool availability in a block 302, check each tool current setup in a block 304, check priority of lots in a block 306, check remaining species time for each tool in a block 308, check remaining lots in a block 310, check recipe availability in a block 312, operator decisions in a block 314, decide final ranking of lots in a block 316, or dispatch lot in a block 320. Automatic decision-making or dispatching of some the manufacturing processes, such as three hundred millimeter wafer processing, can include unique processes such as open dispatch screen in a block 318.

For example a two hundred millimeter wafer automatic decision-making and dispatching process can include check tool availability in the block 302, check each tool current setup in the block 304, check priority of lots in the block 306, check remaining species time for each tool in the block 308, check remaining lots in the block 310, check recipe availability in the block 312, operator decisions in the block 314, decide final ranking of lots in the block 316, and dispatch lot in the block 320.

Further, for example a three hundred millimeter wafer automatic decision-making and dispatching process can include check tool availability in the block 302, check each tool current setup in the block 304, check priority of lots in the block 306, check remaining species time for each tool in the block 308, check remaining lots in the block 310, check recipe availability in the block 312, operator decisions in the block 314, decide final ranking of lots in the block 316, open dispatch screen in the block 318, and dispatch lot in the block 320.

Referring now to FIG. 4, therein is shown an isometric view of the manufacturing system 100. The manufacturing system 100 includes the primary server 102, the schedule server 104, the first process server 106, and the second process server 108. The primary server 102, the schedule server 104, the first process server 106, and the second process server 108 are connected by a network 402. The network 402 can provide interaction between the primary server 102, the schedule server 104, the first process server 106, and the second process server 108.

The primary server 102 and the schedule server 104 can detect an event trigger from the network 402 and form substantially the same control jobs. The primary server 102 can transmit the control job through the network 402 to the first process server 106 or the second process server 108. The schedule server 104 can check status of the primary server 102 and validate the status results with a validation process such as the validation process in the block 110 of FIG. 1 or the validation process in the block 222 of FIG. 2.

If the status of the primary server 102 and the results of the validation process confirm that the primary server 102 did not transmit the control job, the schedule server 104 transmits the control job through the network 402. The schedule server 104 can transmit the control job through the network 402 after a delay, such as twenty to forty seconds from forming the control job. The delay, the status check, or the validation process provides elimination of more than one of the same control job in the manufacturing system 100.

Referring now to FIG. 5, therein is shown a flow chart of a manufacturing system 500 for implementing the manufacturing system 100 in an embodiment of the present invention. The system 500 includes providing an event trigger to a primary server and a schedule server in a block 502; forming a control job by the primary server and the schedule server in a block 504; checking status of the primary server with a delay by the schedule server in a block 506; and validating the status of the primary server with a validation process before the schedule server transmits the control job in a block 508.

In greater detail, a system to provide the method and apparatus of the manufacturing system 100, in an embodiment of the present invention, is performed as follows:
1. Providing an event trigger to a network.
2. Connecting a primary server and a schedule server to the network.
3. Forming a control job by the primary server and the schedule server.
4. Checking status of the primary server with a delay by the schedule server.
5. Validating the status of the primary server with a validation process before the schedule server provides the control job.

Thus, it has been discovered that the manufacturing system method and apparatus of the present invention furnish important and heretofore unknown and unavailable solutions, capabilities, and functional aspects. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations, which fall within the scope of the included claims. All matters hithertofore set forth herein or shown in the accompanying drawings are to be interpreted in an illustrative and non-limiting sense.

What is claimed is:

1. A manufacturing system comprising:
providing an event trigger to a primary server and a schedule server;
forming a control job by the primary server and the schedule server;
checking status of the primary server with a delay by the schedule server; and
validating the status of the primary server with a validation process before the schedule server transmits the control job.

2. The system as claimed in claim 1 wherein forming the control job includes transmitting the control job by the primary server.

3. The system as claimed in claim 1 wherein checking the status includes verifying the primary server forms and transmits the control job.

4. The system as claimed in claim 1 wherein validating the status includes validating a process server.

5. The system as claimed in claim 1 wherein validating the status includes validating a lot reservation.

6. A manufacturing system comprising:
providing an event trigger to a network;
connecting a primary server and a schedule server to the network;
forming a control job by the primary server and the schedule server based on the event trigger from the network;
checking status through the network of the primary server with a delay by the schedule server; and
validating the status of the primary server with a validation process before the schedule server provides the control job to the network.

7. The system as claimed in claim 6 wherein forming the control job includes transmitting the control job by the primary server to a process server.

8. The system as claimed in claim 6 wherein checking the status includes verifying the primary server forms and transmits the control job to a process server.

9. The system as claimed in claim 6 wherein validating the status includes validating a process server.

10. The system as claimed in claim 6 wherein validating the status includes validating a lot reservation.

11. A manufacturing system comprising:
a primary server;
a schedule server connected to the primary server; and
a process server connected to the primary server and the schedule server.

12. The system as claimed in claim 11 wherein the primary server includes a reservation application.

13. The system as claimed in claim 11 wherein the primary server includes a control job application.

14. The system as claimed in claim 11 wherein the schedule server includes a control job application.

15. The system as claimed in claim 11 wherein the schedule server includes an active feedback application.

16. The system as claimed in claim 11 wherein:
the primary server is connected to a network;
the schedule server is connected to the network and the primary server; and
the process server is connected to the network, the primary server, and the schedule server.

17. The system as claimed in claim 11 wherein the primary server includes a reservation application for a returned lot list.

18. The system as claimed in claim 11 wherein the primary server includes a real time dispatch application.

19. The system as claimed in claim 11 wherein the schedule server includes a real time dispatch application.

20. The system as claimed in claim 11 wherein the schedule server includes an active feedback application and a validation application.
